(19) United States
(12) Patent Application Publication
(10) Pub. No.: US 2022/0063014 A1
(43) Pub. Date: Mar. 3, 2022

(54) MESH FUSION DEVICE FOR COSMETIC CONTAINER

(71) Applicant: PUM-TECH KOREA CO., LTD, Incheon (KR)

(72) Inventor: Do Hoon LEE, Incheon (KR)

(21) Appl. No.: 17/393,274

(22) Filed: Aug. 3, 2021

(30) Foreign Application Priority Data
Aug. 25, 2020 (KR) 10-2020-0106913

(51) Int. Cl. B23K 20/02; B23K 37/04; B23K 20/10; A45D 34/00; A45D 40/00

(52) U.S. Cl. CPC B23K 20/02; B23K 37/0443; B23K 20/10; A45D 2040/0006; A45D 40/00; A45D 2034/002; A45D 34/00

(57) ABSTRACT

According to one embodiment of the present invention, a mesh fusion device for a cosmetic container includes: a frame support unit on which a frame is seated; first and second fixing plates adjacent to the frame support unit, having first and second through-holes, respectively, and configured to press top and bottom surfaces of a mesh inserted between the first and second fixing plates while overlapping each other; and a fusion unit for fusing the mesh fitted between the first and second fixing plates to one surface of the frame while pressing and expanding the mesh.

### CROSS-REFERENCE TO RELATED APPLICATION

This application claims the benefit of Korean Application No. 10-2020-0106913 filed on Aug. 25, 2020 with the Korean Intellectual Property Office, the disclosure of which is incorporated herein by reference.

### BACKGROUND OF THE INVENTION

### 1. Field of the Invention

The present invention relates to a mesh fusion device for a cosmetic container, and more particularly, to a mesh fusion device for a cosmetic container, in which a mesh is inserted between the first and second fixing plates overlapping each other so that the whole mesh is pressed and fixed, and as an interval between the first and second fixing plates and the frame support unit is changed, the mesh is fused to the frame with a uniform tension over an entire area thereof, and the tension of the whole mesh is freely adjusted.

### 2. Description of the Related Art

A cosmetic product refers to an article that is used for a human body in order to add the charm of the human body and change the appearance of the human body brighter by making the human body clean and beautiful, or to maintain or promote the health of the skin or hair.

According to the purpose of use, the cosmetic product is classified into face-washing cosmetics used to remove sebum, wastes, and contaminants from a skin surface, basic cosmetics used to appropriately supply moisture and oil to the skin, color cosmetics used to express beautiful colors, hair cosmetics used to protect and nourish the hair while removing foreign substances from the hair or scalp, perfumes having fragrant materials dissolved in alcohol and used to exude fragrances to other people, and the like.

As cosmetic products are developed as described above, the development of various cosmetic containers for accommodating cosmetic materials is also required.

In general, among the cosmetic products, cosmetic products that have a liquid or gel form, such as a lotion, cream, foundation, gel, shampoo, and conditioner, are stored in a container having an open top and having an open/close function, and used by taking some cosmetic products out of the container with a finger or a makeup tool such as a puff and applying the cosmetic products to the skin. Recently, in order to allow cosmetic products accommodated in a cosmetic container to be uniformly smeared onto a makeup tool, a cosmetic container including a mesh formed of an elastic material has been developed and used.

As a conventional cosmetic container as described above, Korean Utility Model Registration No. 20-0472370 has been disclosed, in which the conventional cosmetic container includes a container body in which a cosmetic product is accommodated, a middle cap coupled to an inlet portion of the container body, and an elastic mesh bonded to an inner side of the middle cap by ultrasonic fusion. When briefly reviewing a process of ultrasonically fusing the elastic mesh of the conventional cosmetic container to the middle cap as described above, an operator places the middle cap on the elastic mesh and ultrasonically fuses the elastic mesh to the middle cap by using an ultrasonic fusion device.

However, in the conventional ultrasonic fusion structure, the mesh is fused to the middle cap without being pulled taut, so that a tension of the mesh may be reduced. Accordingly, when used for a long period of time, the mesh may sag downward by a weight of the cosmetic product absorbed by the mesh, so that a function of the mesh may not be performed properly.

In order to solve the problems as described above, Korean Patent Registration No. 10-1691789 has disclosed an ultrasonic fusion apparatus for a screening net and an annular member. According to the related art, an annular member supply line, a screening net supply line, and an ultrasonic fusion device are provided in one work table so as to increase productivity, and an annular member support piece ascends higher than a net flange when the annular member is fused to the screening net by the ultrasonic fusion device so that the screening net may be fused to the annular member in a taut state.

However, since the related art has a structure in which the annular member support piece provided in the ultrasonic fusion device ascends by an ascending/descending actuator to ascend higher than a height of the net flange by a predetermined height while supporting the screening net and the annular member from bottoms thereof so that the screening net is maintained taut only at a portion between a start point of a screening net winding roll and an end point of a driving roller provided in a withdrawal driving unit, when the screening net is fused to the annular member, the screening net may not have a uniform tension over the whole edge of the screening net, and a magnitude of the tension of the screening net fused to the annular member may not be freely adjusted according to a container structure to which the screening net is applied or a type of a cosmetic product in which the screening net is used.

In other words, according to the related art, in a process of expanding the screening net, the screening net is pulled taut only in one direction, that is, one direction according to both axes from the start point of the screening net winding roll to the end point of the driving roller, whereas the screening net is fused to the annular member without being pulled at all in a direction intersecting the above direction. Accordingly, when the annular member is coupled to a container for use, the screening net fused to the annular member may be wrinkled at a portion thereof having no tension as the screening net retains a cosmetic product, so that usability and an aesthetic impression of the screening net may be deteriorated.

Therefore, it is necessary to develop a mesh fusion device for a cosmetic container, in which an entire area of a screening net fused to an annular member having a ring shape expands toward an edge portion of the annular member to have a uniform tension, and the tension of the screening net may be freely adjusted according to a structure of the cosmetic container or a type of a cosmetic product stored in the cosmetic container.

### DOCUMENTS OF RELATED ART

### Patent Documents

(Patent document 0001) Korean Utility Model Registration No. 20-0472370 (published on Apr. 24, 2014)

(Patent document 0002) Korean Patent Registration No. 10-1691789 (published on Jan. 10, 2017)

### SUMMARY OF THE INVENTION

In order to solve the problems described above, an object of the present invention is to provide a mesh fusion device for a cosmetic container, in which first and second fixing plates having first and second through-holes press an entire area of top and bottom surfaces of a mesh inserted between the first and second fixing plates while overlapping each other, and the mesh is fused to a frame while being pressed and expanded by a fusion unit, so that the mesh may have a uniform tension over the entire area thereof from a central portion toward an edge portion of the frame, and thus the mesh may be maintained taut even when retaining a cosmetic product.

In addition, an object of the present invention is to provide a mesh fusion device for a cosmetic container, in which an interval between the mesh fitted between the first and second fixing plates and the frame seated on a frame support unit is changed as the first and second fixing plates move so as to freely adjust a magnitude of the tension of the whole mesh fused to the frame, so that the mesh may be applied to cosmetic containers having various structures that require different magnitudes of tension, various types of cosmetic products stored in the cosmetic container, or the like.

In order to achieve the objects described above, according to the present invention, there is provided a mesh fusion device for a cosmetic container, the mesh fusion device including: a frame support unit on which a frame is seated; first and second fixing plates adjacent to the frame support unit, having first and second through-holes, respectively, and configured to press top and bottom surfaces of a mesh inserted between the first and second fixing plates while overlapping each other; and a fusion unit for fusing the mesh fitted between the first and second fixing plates to one surface of the frame while pressing and expanding the mesh.

In addition, a frame seating part may protrude from one surface of the frame support unit, and the frame may be seated on the frame seating part while covering at least a portion of the frame seating part.

In addition, the frame support unit may include at least one guide rod, and the first and second fixing plates may include at least one first guide hole and at least one second guide hole, respectively, which are coupled with the at least one guide rod, so that vertical movements of the first and second fixing plates may be guided.

In addition, the first and second fixing plates may be spaced apart from each other by a predetermined interval, and may make close contact with each other with the mesh inserted or fixed therebetween, such that the top and bottom surfaces of the mesh are partially exposed to an outside by the first and second through-holes of the first and second fixing plates.

In addition, a top surface of the first fixing plate except for the first through-hole and a bottom surface of the second fixing plate except for the second through-hole may press an entire area of the top and bottom surfaces of the mesh located therebetween.

In addition, a fitting protrusion may be formed on one of the first and second through-holes of the first and second fixing plates, and a fitting groove may be formed in a remaining one of the first and second through-holes of the first and second fixing plates, so that the fitting protrusion and the fitting groove may be coupled to each other.

In addition, the fusion unit may move vertically to pass through the first and second through-holes of the first and second fixing plates, and may sequentially press the mesh to the one surface of the frame to fuse the mesh to the frame.

In addition, the fusion unit, the first and second fixing plates, and the frame support unit are preferably located in a straight line.

In addition, an interval between the first and second fixing plates and the frame support unit may be changed as the first and second fixing plates move up and down, thereby adjusting a tension of the mesh fused to the frame.

In addition, the mesh fusion device may further include a fixing unit adjacent to the frame support plate to fix the frame support plate.

According to an embodiment of the present invention, the first and second fixing plates having the first and second through-holes press the entire area of the top and bottom surfaces of the mesh inserted between the first and second fixing plates while overlapping each other, and the mesh is fused to the frame while being pressed and expanded by the fusion unit, so that the mesh can have a uniform tension over the entire area thereof from the central portion toward the edge portion of the frame, and thus the mesh can be maintained taut even when retaining the cosmetic product.

In addition, according to an embodiment of the present invention, the interval between the mesh fitted between the first and second fixing plates and the frame seated on the frame support unit is changed as the first and second fixing plates move so as to freely adjust the magnitude of the tension of the whole mesh fused to the frame, so that the mesh can be applied to cosmetic containers having various structures that require different magnitudes of tension, various types of cosmetic products stored in the cosmetic container, or the like.

### BRIEF DESCRIPTION OF THE DRAWINGS

FIG. 1 is a perspective view showing a mesh fusion device according to one embodiment of the present invention.

FIG. 2 is an exploded perspective view showing the mesh fusion device according to one embodiment of the present invention.

FIG. 3 is a perspective view illustrating a state in which first and second fixing plates are spaced apart from each other according to one embodiment of the present invention.

FIG. 4 is a perspective view illustrating a state in which a frame is seated on a frame support unit according to one embodiment of the present invention.

FIG. 5 is a perspective view illustrating a state in which a mesh is inserted between the first and second fixing plates according to one embodiment of the present invention.

FIG. 6 is a perspective view illustrating a state in which the first and second fixing plates overlap each other according to one embodiment of the present invention.

FIG. 7 is a front view illustrating a state in which the mesh is expanded and fused as a fusion unit moves downward according to one embodiment of the present invention.

FIG. 8 is a plan view illustrating a state in which the mesh is expanded and fused by the fusion unit according to one embodiment of the present invention.

FIG. 9 is a front view illustrating a state in which the first and second fixing plates are spaced apart from each other as the fusion unit moves upward according to one embodiment of the present invention.

FIG. 10 is a perspective view illustrating a state in which an interval between the first and second fixing plates and the frame support unit is adjusted as the first and second fixing plates move according to one embodiment of the present invention.

### DETAILED DESCRIPTION OF THE INVENTION

The following detailed descriptions of the present invention are given for embodiments in which the present invention may be practiced, and refer to the accompanying drawings that illustrate the embodiments. These embodiments are described in sufficient detail to enable those skilled in the art to practice the present invention. It should be understood that various embodiments of the present invention are different from each other, but need not be mutually exclusive. For example, specific shapes, structures, and characteristics described herein may be implemented and changed from one embodiment to another embodiment without departing from the spirit and scope of the present invention. In addition, it should be understood that a position or arrangement of individual elements within each embodiment described herein may vary without departing from the spirit and scope of the present invention.

Therefore, the following detailed description is not to be taken in a limiting sense, and the scope of the invention is defined only by the appended claims while encompassing the scope of all equivalents of the claimed invention when appropriately described. In the drawings, like reference numerals refer to elements that perform like or similar functions in various aspects.

Regarding the terms used herein, general terms that are currently used as widely as possible are selected in consideration of functions thereof in the present invention. However, the meanings of the terms may vary according to the intention of those skilled in the art, judicial precedents, the emergence of new technologies, and the like. In addition, in certain cases, a term may be selected at discretion of the applicant. In this case, the meaning of the term will be described in detail at a corresponding part in the description of the invention. Therefore, the terms used herein should be defined based on the meanings of the terms and the contents throughout the present disclosure without being simply limited to names of the terms.

Throughout the present disclosure, when some part “includes” some elements, unless explicitly described to the contrary, it means that other elements may be further included but not excluded. In addition, any term including “part”, “module”, and the like in the specification refers to a unit for processing at least one function or operation, and may be implemented as hardware, software, or a combination of hardware and software.

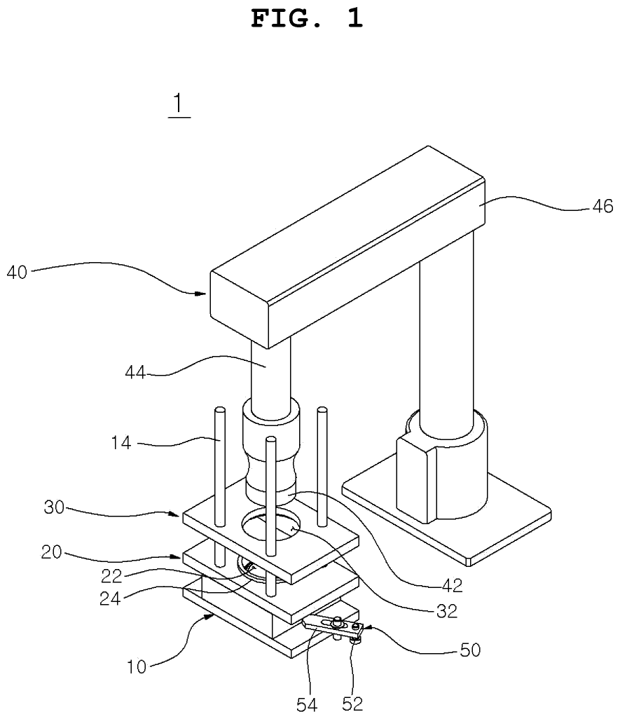

Hereinafter, a mesh fusion device for a cosmetic container according to one embodiment of the present invention will be described with reference to FIGS. 1 to 10. In the following, preferred embodiments of the present invention will be described with reference to the accompanying drawings, and the mesh fusion device for the cosmetic container according to the present invention preferably includes the following components, but the embodiments are not limited thereto.

FIG. 1 is a perspective view showing a mesh fusion device according to one embodiment of the present invention, and FIG. is an exploded perspective view showing the mesh fusion device according to one embodiment of the present invention.

As shown in the drawings, according to one embodiment of the present invention, a mesh fusion device 1 for a cosmetic container refers to a device for fusing a mesh 70 to one surface of a frame 60, and may include a frame support unit 10, first and second fixing plates 20 and 30, and a fusion unit 40. In this case, the frame 60 refers to a component for fixing the mesh 70 to the cosmetic container, and may be formed in a ring shape and coupled to an open portion of the container in which a cosmetic product is accommodated. In addition, the mesh 70 refers to a fabric formed of an elastic material that is densely perforated like a net, and may be fused to the one surface of the frame 60 and elastically pressed by a user to discharge the cosmetic product through fine holes.

Hereinafter, the mesh fusion device for the cosmetic container according to one embodiment of the present invention will be described for each component.

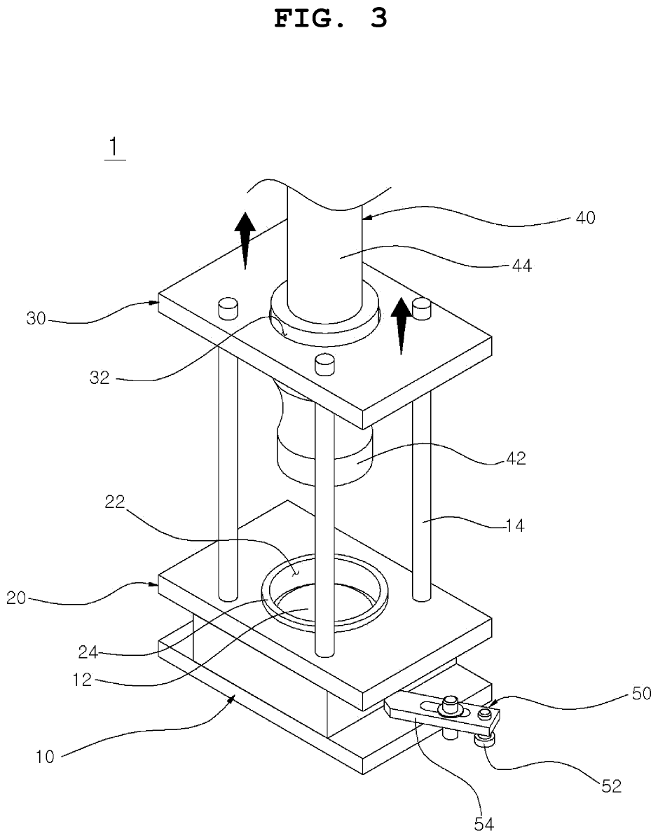

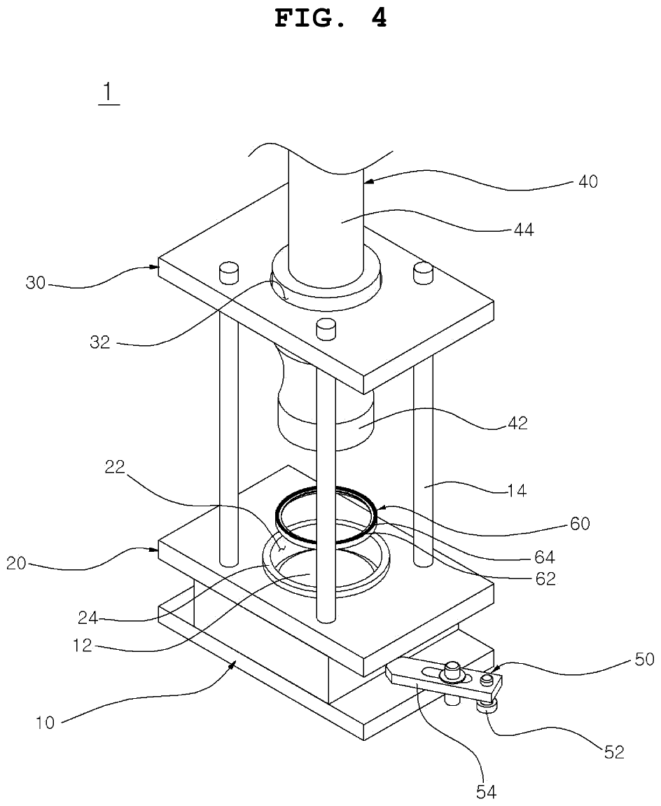

FIG. 3 is a perspective view illustrating a state in which first and second fixing plates are spaced apart from each other according to one embodiment of the present invention, and FIG. 4 is a perspective view illustrating a state in which a frame is seated on a frame support unit according to one embodiment of the present invention.

The frame support unit 10 refers to a part on which the frame 60 is fixedly seated, and may have a three-dimensional shape having a predetermined area so that the frame 60 may be easily seated on a top surface of the frame support unit 10. Although the frame support unit 10 has been shown in the drawings of the mesh fusion device according to one embodiment of the present invention as having a rectangular parallelepiped shape, the embodiments are not limited thereto, and the frame support unit 10 may have various shapes or sizes in consideration of a work space, work efficiency, and a shape or a size of the frame.

A frame seating part 12 may protrude from the top surface of the frame support unit 10, and the frame 60 may be seated on the frame seating part 12 while covering at least a portion of the frame seating part 12. The frame seating part 12 may protrude by a predetermined height, and may be configured in the form of a disc formed at an upper edge thereof with a stepped sill. As shown in FIG. 4, the frame 60 may be configured in the form of a ring including a side wall part 62 and a horizontal extension part 64 bent inward of the side wall part 62, and may be seated on the frame seating part 12. In this case, the frame 60 may be seated on the frame seating part 12 such that the side wall part 62 of the frame 60 may surround an outer wall of the frame seating part 12, and the horizontal extension part 64 may cover an edge portion of the frame seating part 12. Accordingly, the frame 60 may be maintained in a fixed state without fluctuating due to an external impact during a process of fusing the mesh 70. In this case, it may be preferable to allow a diameter of the frame seating part 12 to be equal to or relatively smaller than an inner diameter of the frame 60. However, the shape of the frame seating part 12 is not limited to a disc shape, and may vary according to the shape or the size of the frame 60 seated on the frame seating part 12.

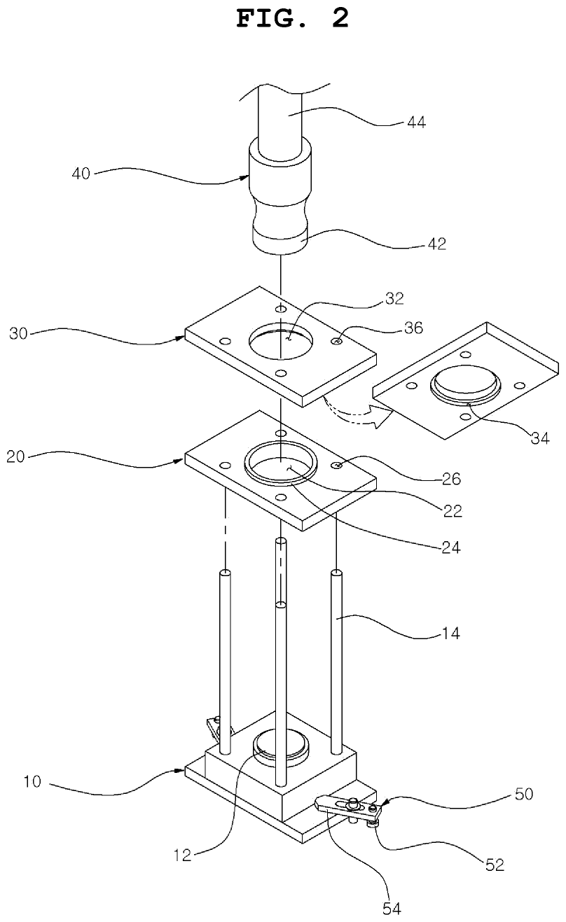

In addition, the frame support unit 10 may be formed on one surface thereof with at least one guide rod 14 for guiding vertical movements of the first and second fixing plates 20 and 30. In this case, as shown in FIG. 2, the guide rod 14 may extend upward from a corner of the frame support unit 10, and may pass through the first and second fixing plates 20 and 30 to guide the vertical movements of the first and second fixing plates 20 and 30.

Meanwhile, a fixing unit 50 may be further installed so as to be adjacent to the frame support unit 10. As shown in FIG. 1, the fixing unit 50 may include a rotation shaft 52 and a fixing part 54 rotated by the rotation shaft 52, in which the fixing part 54 may be rotated by a predetermined angle while being maintained horizontally, and may make close contact with one side surface of the frame support unit 10 to prevent the frame support unit 10 from fluctuating. However, at least two fixing units 50 are preferably provided on an outer side of the frame support unit 10 to stably fix the frame support unit 10.

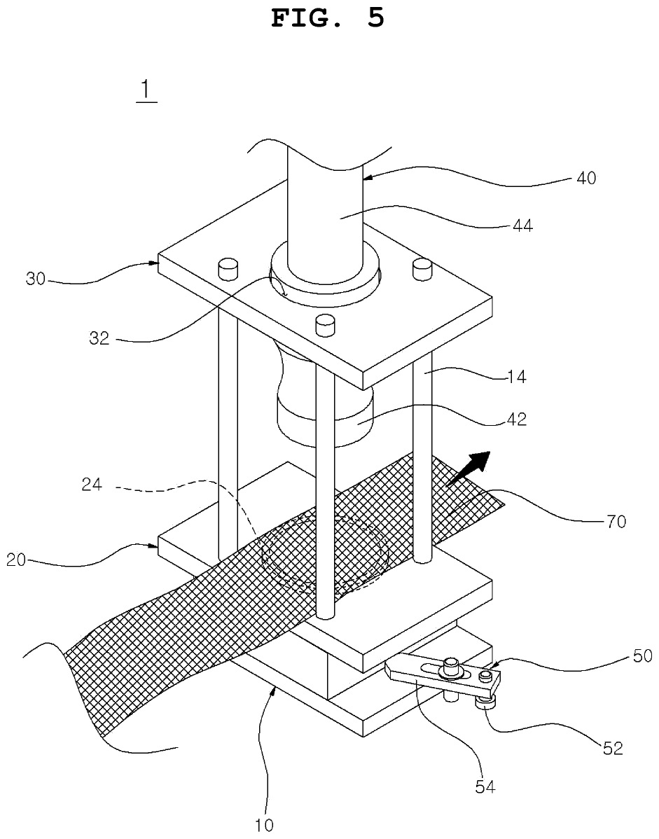

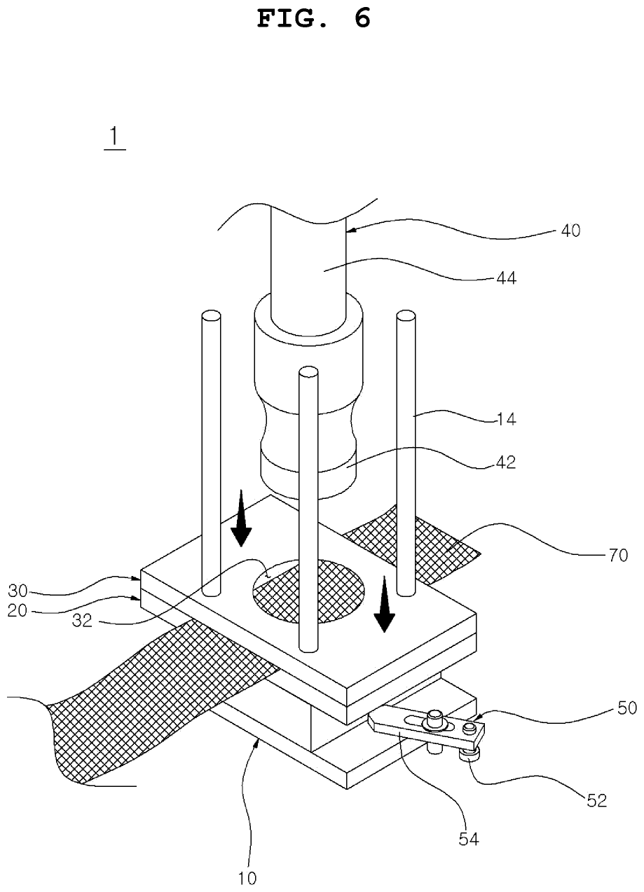

FIG. 5 is a perspective view illustrating a state in which a mesh is inserted between the first and second fixing plates according to one embodiment of the present invention, and FIG. 6 is a perspective view illustrating a state in which the first and second fixing plates overlap each other according to one embodiment of the present invention.

The first and second fixing plates 20 and 30 may be installed adjacent to the frame support unit 10 to fix the mesh 70. The first and second fixing plates 20 and 30 may be arranged under and over each other, so that the first and second fixing plates 20 and 30 may be spaced apart from each other by a predetermined interval to allow the mesh 70 to be inserted therebetween or withdrawn to an outside as shown in FIG. 5, and the first and second fixing plates 20 and 30 may make close contact with each other to allow the mesh 70 to be fixedly fitted therebetween as shown in FIG. 6. In this case, as shown in FIG. 3, while the first fixing plate 20 arranged on a lower side among the first and second fixing plates 20 and 30 is fixed, only the second fixing plate 30 arranged on an upper side among the first and second fixing plates 20 and 30 may move reciprocally and vertically by a predetermined interval so that the first and second fixing plates 20 and 30 may be spaced apart from each other or may make close contact with each other, which is to maintain a constant interval between the first fixing plate 20 and the frame support unit 10.

In this case, the first and second fixing plates 20 and 30 may correspond to each other, and may have a polygonal plate shape having a predetermined area, which is preferably a rectangular plate shape.

As shown in FIG. 2, the first and second fixing plates 20 and 30 may have first and second through-holes 22 and 32, respectively, in which bottom and top surfaces of the mesh 70 fitted between the first and second fixing plates 20 and 30 may be at least partially exposed to the outside through the first and second through-holes 22 and 32, and the fusion unit 40 may be inserted into the first and second through-holes 22 and 32. Therefore, the first and second through-holes 22 and 32 preferably have the same diameter as the fusion unit 40 or a diameter that is relatively larger than a diameter of the fusion unit 40. Meanwhile, the first through-hole 22 among the first and second through-holes 22 and 32 may serve as an inlet into which the frame 60 is inserted before the mesh 70 is located between the first fixing plate 20 and the second fixing plate 30. In more detail, in order to simplify the process of fusing the mesh 70, the first fixing plate 20 spaced apart from the frame support unit 10 by a predetermined interval may be fixed, only the second fixing plate 30 may move upward as shown in FIG. 3, and the frame 60 may be inserted into the first through-hole 22 of the first fixing plate 20 so as to be seated on the frame seating part 12 of the frame support unit 10 as shown in FIG. 4.

A fitting protrusion 24 may be formed on an outer side of one of the first and second through-holes 22 and 32 of the first and second fixing plates 20 and 30, and a fitting groove 34 may be formed on an outer side of the remaining one of the first and second through-holes 22 and 32 of the first and second fixing plates 20 and 30, so that the fitting protrusion 24 and the fitting groove 34 may be coupled to each other. In this case, it may be appropriate that the fitting protrusion 24 has a ring shape protruding from one surface of the first fixing plate 20, that is, a surface facing the second fixing plate 30, and the fitting groove 34 has a ring shape recessed from one surface of the second fixing plate 30, that is, a surface facing the first fixing plate 20. Through a coupling structure of the fitting protrusion 24 and the fitting groove 34 as described above, the first and second fixing plates 20 and 30 may overlap each other while being accurately engaged with each other, and the first and second through-holes 22 and 32 may be located on the same line without being offset to each other in a process of expanding and fusing the mesh 70. In addition, the mesh 70 may be bent along outer edges of the first and second through-holes 22 and 32 due to the fitting protrusion 24 and the fitting groove 34 while being inserted between the first and second fixing plates 20 and 30, so that the mesh 70 may be stably fixed without being easily separated.

In addition, the first and second fixing plates 20 and 30 may have at least one first guide hole 26 and at least one second guide hole 36, respectively, so that the vertical movements of the first and second fixing plates 20 and 30 may be guided. The guide rod 14 of the frame support unit 10 may pass through the first and second guide holes 26 and 36, and the first and second guide holes 26 and 36 are preferably spaced outward from the first and second through-holes 22 and of the first and second fixing plates 20 and 30 by a predetermined interval. Although four guide rods 14, four first guide holes 26, and four second guide holes 36 have been illustrated in the drawings according to one embodiment of the present invention, the embodiments are not limited thereto, and the number of guide rods 14 and first and second guide holes 26 and 36 may vary in consideration of stability or rapidity of movements of the first and second fixing plates 20 and 30 and smoothness of work.

As described above, according to the mesh fusion device 1 of one embodiment of the present invention, the top and bottom surfaces of the mesh 70 may be simultaneously pressed and fixed by using the first and second fixing plates 20 and 30, so that the mesh 70 may be fused to the one surface of the frame 60 with a uniform tension over an entire area thereof.

In other words, conventionally, a mesh is fused to a frame while expanding the mesh in a state where only both end portions of the mesh in a direction in which the mesh proceeds or four corners of the mesh are fixed, so that a tension may be applied only toward a fixed portion from a center of the mesh. Accordingly, when the frame is coupled to a cosmetic container for use, the mesh fused to the frame may be wrinkled in a direction having no tension as the mesh retains a cosmetic product, so that usability and an aesthetic impression of the mesh may be deteriorated.

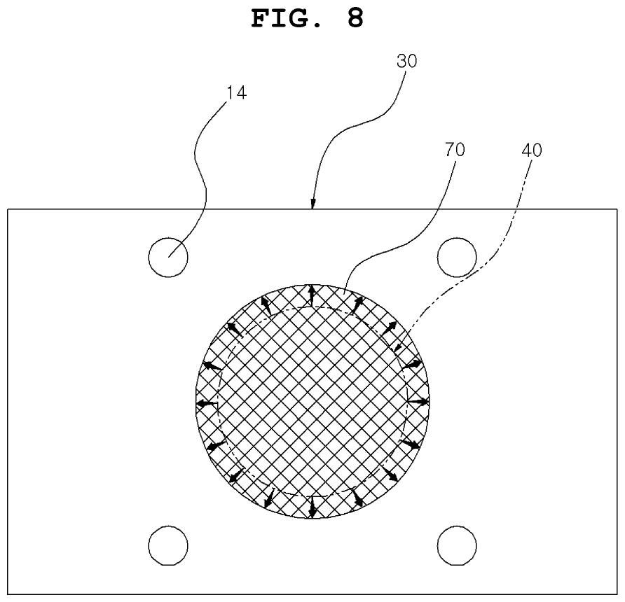

Thus, according to the mesh fusion device 1 of one embodiment of the present invention, as shown in FIG. 6, the first fixing plate 20 serving as a lower plate and the second fixing plate 30 serving as an upper plate may overlap each other, so that a top surface of the first fixing plate 20 except for the first through-hole 22 and a bottom surface of the second fixing plate 30 except for the second through-hole 32 may strongly press an entire area of a predetermined region of the top and bottom surfaces of the mesh 70 located therebetween so as to stably fix the mesh 70. Thereafter, the mesh 70 may be fused to the one surface of the frame 60 while being pressed and pulled by the fusion unit 40. Accordingly, as shown in FIG. 8, the whole mesh 70 may expand from a central portion toward an edge portion of the frame 60 with a uniform tension, so that the mesh 70 may be always maintained taut even when the mesh 70 is used for a long period of time while retaining the cosmetic product.

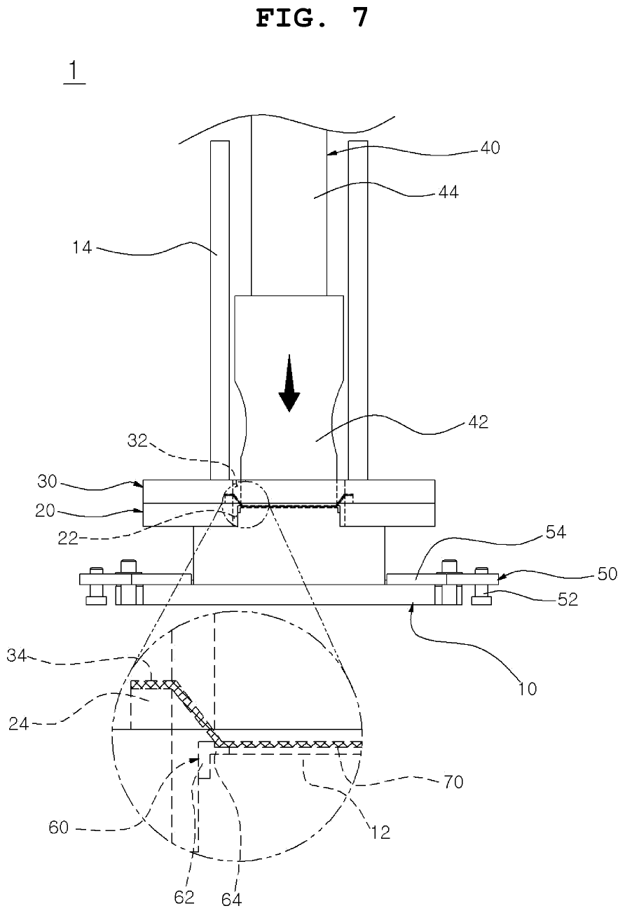

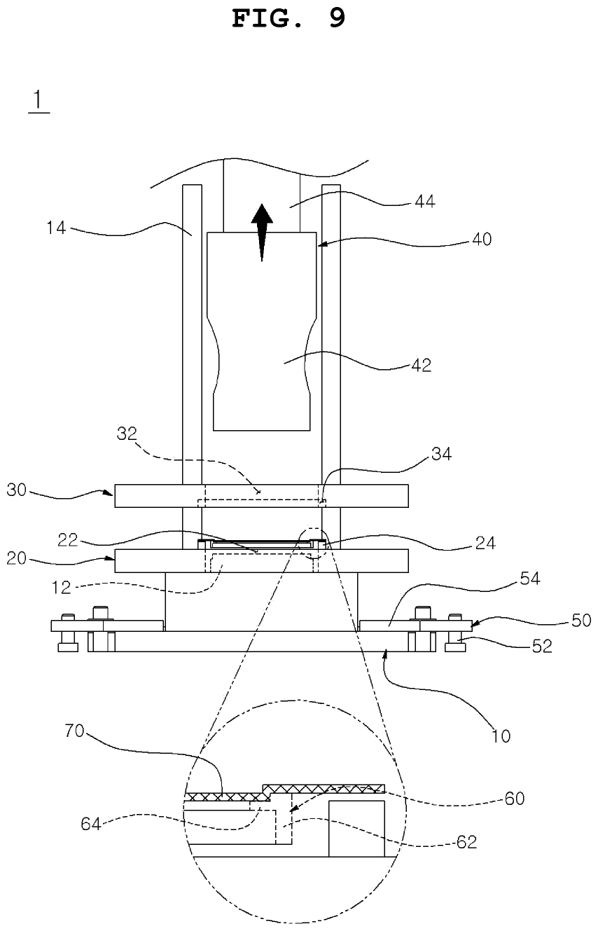

FIG. 7 is a front view illustrating a state in which the mesh is expanded and fused as a fusion unit moves downward according to one embodiment of the present invention, FIG. 8 is a plan view illustrating a state in which the mesh is expanded and fused by the fusion unit according to one embodiment of the present invention, and FIG. 9 is a front view illustrating a state in which the first and second fixing plates are spaced apart from each other as the fusion unit moves upward according to one embodiment of the present invention.

The fusion unit 40 may fuse the mesh 70 to the one surface of the frame 60 while moving reciprocally and vertically, such that an end portion of the fusion unit 40 may pass through the first and second through-holes 22 and 32 of the first and second fixing plates 20 and 30, and may fuse the mesh 70 to the frame 60 while pressing and expanding the mesh 70.

As shown in FIG. 1, the fusion unit 40 may include a fusion part 42 for fusing the mesh 70 to the frame 60 by pressing the mesh 70, a vertical movement part 44 for reciprocally and vertically moving the fusion part 42, and a support body 46 for supporting and fixing the fusion part 42 and the vertical movement part 44. In this case, the fusion part 42 may be configured as: a hot-plate fusion device, an impulse sealer, or a hot-air fusion device, which heats from an outside; or a high-frequency fusion device or an ultrasonic fusion device, which heats a material. In particular, the fusion part 42 is preferably an ultrasonic fusion device. The vertical movement part 44 is preferably operated by a pneumatic cylinder (a mechanism in which a piston performs a reciprocating motion by using a pneumatic pressure), a hydraulic cylinder (a mechanism in which a piston performs a reciprocating motion by using a hydraulic pressure), or a motor (a powered machine for rotating by receiving a power, and generating a rotational force to a shaft thereof), but is not limited thereto. The vertical movement part 44 may be replaced with various mechanisms capable of reciprocally and vertically operating the fusion part 42 smoothly.

As shown in FIG. 7, the fusion part 42 of the fusion unit 40 may move downward by the vertical movement part 44 so as to be inserted into the first and second through-holes 22 and 32, and an end portion of the fusion part 42 may sequentially press the mesh 70 fitted between the first and second fixing plates 20 and 30 to expand the whole mesh 70 as shown in FIG. 8 and fuse the mesh 70 to the one surface of the frame 60 seated on the frame support unit 10. In addition, as shown in FIG. 9, the fusion part 42 of the fusion unit 40 may move upward by the vertical movement part 44 so as to exit from the first and second through-holes 22 and 32, and the second fixing plate 30 among the first and second fixing plates 20 and 30 may sequentially move upward, so that the mesh 70 may be withdrawn or moved.

In this case, it may be appropriate that the fusion unit 40, the first and second fixing plates 20 and 30, and the frame support unit 10 are located in a straight line.

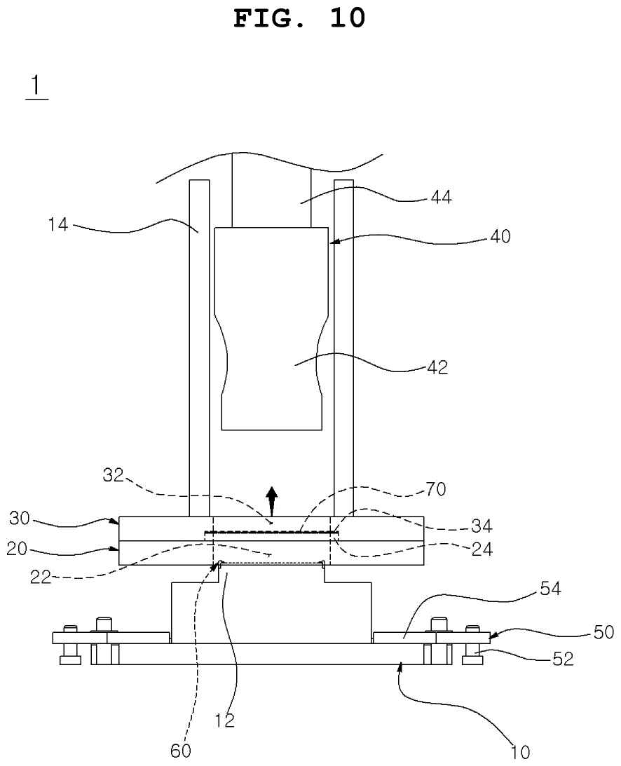

FIG. 10 is a perspective view illustrating a state in which an interval between the first and second fixing plates and the frame support unit is adjusted as the first and second fixing plates move according to one embodiment of the present invention.

The first and second fixing plates 20 and 30 may vertically move up and down together to adjust an interval between the first and second fixing plates 20 and 30 and the frame support unit 10, so that an operator may arbitrarily determine a magnitude of the tension of the mesh fitted between the first and second fixing plates 20 and 30. For example, as shown in FIG. 9, when the first and second fixing plates 20 and move away from the frame support unit 10, an interval between the mesh 70 fixed between the first and second fixing plates 20 and 30 and the frame 60 seated on the frame support unit 10 may be increased, so that when the fusion unit 40 presses the mesh 70 to fuse the mesh 70 to the frame 60, the mesh 70 may be fused to the frame 60 while being relatively more expanded so as to increase the tension. Conversely, when the first and second fixing plates 20 and 30 move close to the frame support unit 10, the interval between the mesh 70 fixed between the first and second fixing plates 20 and 30 and the frame 60 seated on the frame support unit 10 may be decreased, so that when the fusion unit 40 presses the mesh 70 to fuse the mesh 70 to the frame 60, the mesh 70 may be fused to the frame 60 while being relatively less expanded so as to decrease the tension.

Meanwhile, the first and second fixing plates 20 and 30 may move up and down or may be spaced apart from each other and make close contact with each other manually by the operator, or the first and second fixing plates 20 and 30 may move up and down by a predetermined section or may be spaced apart from each other and make close contact with each other automatically by a driving unit (not shown). Similar to the vertical movement part 44 of the fusion unit 40, the driving unit is preferably operated by a pneumatic cylinder (a mechanism in which a piston performs a reciprocating motion by using a pneumatic pressure), a hydraulic cylinder (a mechanism in which a piston performs a reciprocating motion by using a hydraulic pressure), or a motor (a powered machine for rotating by receiving a power, and generating a rotational force to a shaft thereof), but is not limited thereto. The driving unit may be replaced with various mechanisms capable of reciprocally and vertically operating the first and second fixing plates 20 and 30 smoothly.

In addition, when the first and second fixing plates 20 and 30 are operated automatically, a control unit (not shown) for controlling operations of the first and second fixing plates 20 and 30 may be further included. In this case, by operating the driving unit, the control unit (not shown) may move the second fixing plate 30 upward from the first fixing plate 20 by a predetermined section so that the first and second fixing plates 20 and 30 may be spaced apart from each other or move the second fixing plate 30 downward from the first fixing plate 20 by a predetermined section so that the first and second fixing plates 20 and 30 may make close contact with each other, and may vertically move the first and second fixing plates 20 and 30 together by a predetermined height.

As described above, according to the mesh fusion device 1 of one embodiment of the present invention, through vertical reciprocating movements of the first and second fixing plates 20 and 30, the interval between the mesh 70 fitted between the first and second fixing plates 20 and 30 and the frame 60 seated on the frame support unit 10 may be changed so as to freely adjust the magnitude of the tension of the whole mesh 70 fused to the frame 60, so that the mesh 70 may be easily applied to cosmetic containers having various structures that require meshes 70 having different tensions, various types of cosmetic products mounted in the cosmetic container, or the like, and thus compatibility of the mesh 70 may be increased.

FIGS. 3 to 10 are views illustrating an operation of the mesh fusion device according to one embodiment of the present invention, and an operation structure of the mesh fusion device according to one embodiment of the present invention will be described with reference to FIGS. 3 to 10 as follows.

First, as shown in FIG. 3, the first and second fixing plates 20 and 30 may be spaced apart from each other by a predetermined interval. In this case, while the first fixing plate 20 arranged on the lower side among the first and second fixing plates 20 and 30 is fixed, only the second fixing plate 30 arranged on the upper side among the first and second fixing plates 20 and 30 may vertically move by a predetermined interval along the guide rod 14 so as to separate the first and second fixing plates 20 and 30 from each other.

Then, as shown in FIG. 4, the frame 60 may be inserted into the first through-hole 22 of the first fixing plate 20 and seated on the frame seating part 12 of the frame support unit 10. In this case, the frame 60 may be stably seated on the frame seating part 12 such that the side wall part 62 of the frame 60 may surround the outer wall of the frame seating part 12, and the horizontal extension part 64 may cover the edge portion of the frame seating part 12.

Thereafter, as shown in FIG. 5, an elastic mesh 70 may be inserted between the first and second fixing plates 20 and 30 that are spaced apart from each other by a predetermined interval. In this case, the elastic mesh 70 may be inserted between a plurality of guide rods 14, and placed on an upper portion of the fitting protrusion 24 of the first fixing plate 20.

Then, as shown in FIG. 6, the second fixing plate 30 may move downward to overlap the first fixing plate 20. Accordingly, the top surface of the first fixing plate 20 except for the first through-hole 22 and the bottom surface of the second fixing plate 30 except for the second through-hole 32 may press an entire area of a predetermined region of the top and bottom surfaces of the mesh 70 located therebetween so as to fix the mesh 70.

Thereafter, as shown in FIG. 7, the fusion part 42 of the fusion unit 40 may move downward, so that the mesh 70 may be fused to the one surface of the frame 60. In this case, the fusion part 42 of the fusion unit 40 may move downward by the vertical movement part 44 so as to be inserted into the first and second through-holes 22 and 32, and the end portion of the fusion part 42 may sequentially press the mesh 70 fitted between the first and second fixing plates 20 and 30 to expand the whole mesh 70 as shown in FIG. 8 and fuse the mesh 70 to the one surface of the frame 60 seated on the frame support unit 10.

Then, as shown in FIG. 9, the fusion part 42 of the fusion unit 40 may move upward, and the second fixing plate 30 may be spaced apart from the first fixing plate 20 by a predetermined interval. In this case, the fusion part 42 of the fusion unit 40 may move upward by the vertical movement part 44 so as to exit from the first and second through-holes 22 and 32, and the second fixing plate 30 among the first and second fixing plates 20 and 30 may sequentially move upward, so that the mesh 70 may be withdrawn or moved.

While repeatedly performing the above operation, the frame 60 may be inserted into the frame support unit 10, an entire area of the top and bottom surfaces of the mesh 70 may be pressed by using the first and second fixing plates 20 and 30, and the mesh 70 may be fused to the one surface of the frame 60 by the fusion unit 40. Meanwhile, when the tension of the mesh 70 fused to the frame 60 is required to be adjusted, as shown in FIG. 10, the interval between the mesh 70 fitted between the first and second fixing plates 20 and 30 and the frame 60 seated on the frame support unit 10 may be changed by reciprocally and vertically moving the first and second fixing plates 20 and 30.

Although the above description has been made with reference to illustrative embodiments and drawings as well as certain matters such as specific elements, the embodiments are provided for an overall understanding of the present invention, so the present invention is not limited to the embodiments. It will be understood by a person having ordinary skill in the art to which the present invention pertains that various changes and modifications can be made from the above description. Therefore, the spirit of the present invention should not be construed as being limited to the embodiments described herein, and it will be understood that the scope of the spirit of the present invention encompasses the scope of the appended claims and all variations equivalent thereto.

What is claimed is:

1. A mesh fusion device for a cosmetic container, the mesh fusion device comprising:
a frame support unit on which a frame is seated;
first and second fixing plates adjacent to the frame support unit, having first and second through-holes, respectively, and configured to press top and bottom surfaces of a mesh inserted between the first and second fixing plates while overlapping each other; and
a fusion unit for fusing the mesh fitted between the first and second fixing plates to one surface of the frame while pressing and expanding the mesh.

2. The mesh fusion device of claim 1, wherein a frame seating part protrudes from one surface of the frame support unit, and
the frame is seated on the frame seating part while covering at least a portion of the frame seating part.

3. The mesh fusion device of claim 1, wherein the frame support unit includes at least one guide rod, and the first and second fixing plates include at least one first guide hole and at least one second guide hole, respectively, which are coupled with the at least one guide rod, so that vertical movements of the first and second fixing plates are guided.

4. The mesh fusion device of claim 1, wherein the first and second fixing plates are spaced apart from each other by a predetermined interval, and make close contact with each other with the mesh inserted or fixed therebetween, such that the top and bottom surfaces of the mesh are partially exposed to an outside by the first and second through-holes of the first and second fixing plates.

5. The mesh fusion device of claim 1, wherein a top surface of the first fixing plate except for the first through-hole and a bottom surface of the second fixing plate except for the second through-hole press an entire area of the top and bottom surfaces of the mesh located therebetween.

6. The mesh fusion device of claim 1, wherein a fitting protrusion is formed on one of the first and second through-holes of the first and second fixing plates, and a fitting groove is formed in a remaining one of the first and second through-holes of the first and second fixing plates, so that the fitting protrusion and the fitting groove are coupled to each other.

7. The mesh fusion device of claim 1, wherein the fusion unit moves vertically to pass through the first and second through-holes of the first and second fixing plates, and sequentially presses the mesh to the one surface of the frame to fuse the mesh to the frame.

8. The mesh fusion device of claim 1, wherein the fusion unit, the first and second fixing plates, and the frame support unit are located in a straight line.

9. The mesh fusion device of claim 1, wherein an interval between the first and second fixing plates and the frame support unit is changed as the first and second fixing plates move up and down, thereby adjusting a tension of the mesh fused to the frame.

10. The mesh fusion device of claim 1, further comprising a fixing unit adjacent to the frame support plate to fix the frame support plate.
